(19) United States
(12) Patent Application Publication
(10) Pub. No.: US 2012/0326069 A1
(43) Pub. Date: Dec. 27, 2012

(54) STEP TYPE VALVE

(76) Inventors: Katsunori Takai, Tokyo (JP); Masayuki Yokoyama, Tokyo (JP); Satoru Hasegawa, Tokyo (JP)

(21) Appl. No.: 13/583,028

(22) PCT Filed: Jun. 29, 2010
(86) PCT No.: PCT/JP2010/004291

§ 371 Date: Sep. 6, 2012

(51) Int. Cl. F16K 5/00

(52) U.S. Cl. 251/314

(57) ABSTRACT

A valve 33 has a deformed circular shape such that a diameter in an axis orthogonal direction that is orthogonal to a rotation center axis X is longer than that in an axial direction that is parallel to the rotation center axis X, and a front surface of a semicircle on one side of the valve and a rear surface of a semicircle on the other side thereof about the rotation center axis X as a boundary are abutted against valve seats 34a.

### TECHNICAL FIELD

The present invention relates to a step type valve in which a valve abuts against a step provided in a fluid passage.

### BACKGROUND ART

A conventional butterfly valve includes a structure in which an elliptical valve abuts against a fluid passage at an angle (see Patent Documents 1 to 4, for example), a step type valve structure in which a circular valve abuts against a step part provided in the fluid passage, and so on.

In the instance of a structure in which the elliptical valve abuts directly against the fluid passage at an angle, in comparison with the step type valve structure in which the circular valve abuts against the step part provided in the fluid passage, an opening width between the valve and the passage can be reduced even when the same valve opening is provided at the start of a valve opening operation, and thereby a rising flow rate thereof can be suppressed. However, in a valve closing position thereof, in order to ensure that the outer peripheral curved surface of the elliptical valve abuts against the fluid passage at an angle and that a clearance between the valve and the fluid passage is as small as possible, it is necessary that the outer peripheral curved surface of the valve be subjected to an inclining processing and the like. Further, regarding also a valve abutting part (valve seat) in the fluid passage, some degrees of flatness and surface roughness are necessary so that the clearance between the fluid passage and the valve is as small as possible; therefore, there is a problem such that the workings of the valve and the valve seat become complicated. Moreover, at a high temperature, the valve enlarged relatively due to a thermal expansion may be bit into the fluid passage, and it is therefore required that a clearance of a certain degree be secured between the valve and the fluid passage. However, when the clearance is secured in advance, the valve is expanded most greatly at a maximum temperature of a gas temperature, and thereby there exists a clearance not only at a normal temperature but also in the range of a temperature below the maximum temperature; in such a situation, a valve seat leakage thereof may occur. As discussed above, there is a trade-off relationship between valve seat leakage suppression and valve biting avoidance, which makes difficult application thereof to a high temperature fluid.

On the other hand, in the instance of a step type valve structure in which the circular valve abuts against the step part provided in the fluid passage, a front surface on one side of the valve and a rear surface on the other side thereof abut against the step parts (valve seats) about a rotation center axis as a boundary. Thus, the outer peripheral curved surface of the valve does not abut against the fluid passage, and therefore a clearance can be provided between the outer peripheral curved surface of the valve and the fluid passage. Then, by virtue of the clearance, the valve can be prevented from biting into the fluid passage even when the valve thermally expands at a high temperature. Moreover, an overlapping margin is secured between the valve seat and the front and rear surfaces of the valve, and therefore the valve seat leakage can be suppressed during a valve closing operation.

### Prior Art Documents

### Patent Documents

Patent Document 1: Japanese Patent Application Publication No. 2005-299457

Patent Document 2: Japanese Patent Application Publication No. H6-248984

Patent Document 3: Japanese Patent Application Publication No. H6-280627

Patent Document 4: Japanese Patent Application Publication No. H8-303260

### SUMMARY OF THE INVENTION

However, in the instance of the conventional step type valve structure, since the valve is circular, there is a problem such that an opening width is increased between the valve and the valve seat at the start of a valve opening operation, which leads to a higher rising flow rate thereof.

The present invention is made to solve the aforementioned problems, and an object of the invention is to provide a step type valve such that a rising flow rate at the start of a valve opening operation is suppressed.

A step type valve of the present invention includes: a valve shaft that rotates about a rotation center axis; a valve that rotates integrally with the valve shaft, and that has a deformed circular shape such that a diameter in an axis orthogonal direction orthogonal to an axial direction parallel to the rotation center axis is longer than that in the axial direction; and a valve seat having an annular step provided on an inner surface of a fluid passage to abut against a front surface on one side of the valve and a rear surface on the other side thereof about the rotation center axis as a boundary.

According to the invention, since the valve is formed in a deformed circular shape such that the diameter in the axis orthogonal direction orthogonal to the axial direction parallel to the rotation center axis is longer than that in the axial direction, an opening width between the valve and the valve seat at the start of a valve opening operation is reduced, and an overlapping margin between the valve and the valve seat in an opening part is increased, and a clearance between the valve and the fluid passage is reduced, and thereby a fluid is less likely to flow therethrough, to thus provide a step type valve that suppresses a rising flow rate.

### BRIEF DESCRIPTION OF THE DRAWINGS

FIG. 1 is a sectional view showing a configuration of a step type valve according to Embodiment 1 of the present invention.

FIG. 2 shows a configuration of a valve unit according to Embodiment 1, wherein FIG. 2(a) is a sectional view of the valve unit taken along a line A-A in FIG. 1, and FIG. 2(b) is an enlarged view of the valve.

FIG. 3 is a graph showing a relationship between a degree of valve opening and a flow rate with regard to an elliptical valve according to Embodiment 1 and a conventional circular valve.

FIG. 4 is a view showing a modification of the valve according to Embodiment 1.

### BEST MODE FOR CARRYING OUT THE INVENTION

In the following, to describe the present invention in further detail, embodiments of the invention will be described with reference to the attached drawings.

### Embodiment 1

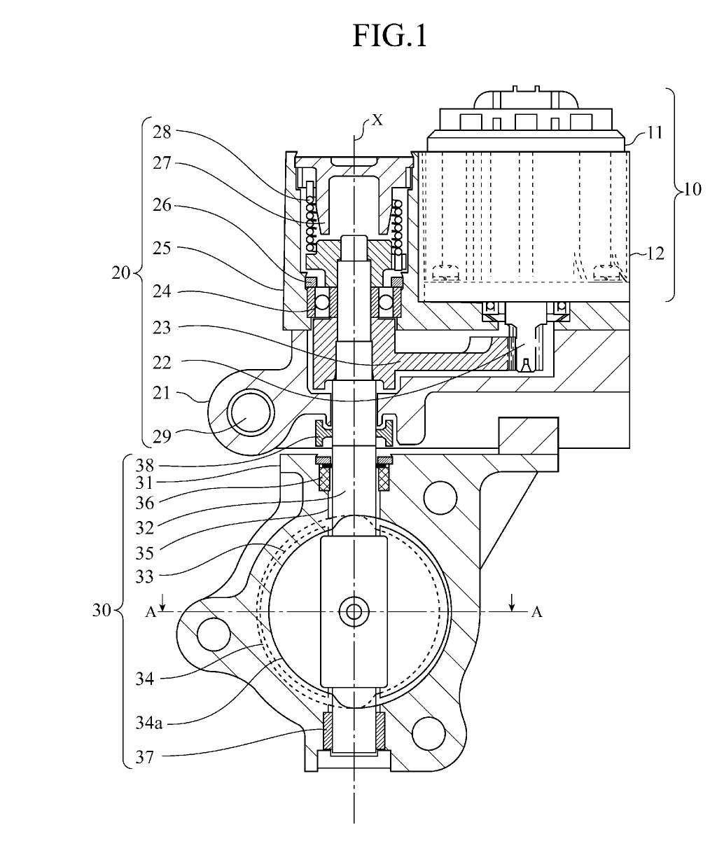

A step type butterfly valve shown in FIG. 1 is composed of: an actuator unit 10 that generates a rotation driving force for opening and closing the valve; a gear unit 20 that transmits the driving force of the actuator unit 10 to a valve shaft 32; and a valve unit 30, interposed in a pipe (not shown) through which a fluid such as high-temperature gas flows, for controlling a flow rate of the fluid by opening and closing a valve 33.

In the actuator unit 10, a DC motor or the like is used as a motor 11, and the motor 11 is covered with a heat shield 12. A pinion gear 22 that extends to an interior of a gearbox 21 is formed on one end side of the output shaft of the motor 11. When the motor 11 is driven to rotate normally or in reverse, the pinion gear 22 rotates with meshed with a gear 23, and thereby the driving force of the motor 11 is transmitted to the valve shaft 32. The valve shaft 32 is fixed to the inner ring of a bearing 24 and pivotally supported to be rotatable, and rotated about a rotation center axis X by the driving force of the motor 11 to thus open and close the valve 33 fixed to the valve shaft 32. In the illustrated example, a pin is fixedly press-fitted in the valve 33 and the valve shaft 32, which may be fastened by caulking, or can be secured with a screw when a gas temperature is low.

The housing of the gear unit 20 is constructed by joining the gear box 21 to a gear cover 25, and the heat shield 12 is formed integrally with the gear cover 25. The outer ring of the bearing 24 is fixed to an interior of the gear cover 25 such that a bottom surface thereof is fit in a step part on an inner peripheral surface of the gear cover 25 and that a plate 26 is fixedly press-fit therein from top. As mentioned above, the inner ring of the bearing 24 is fixed to the valve shaft 32.

Further, a return spring 28 held by a spring holder 27 is disposed on the upper end side of the valve shaft 32 as a failsafe. The return spring 28 biases the valve shaft 32 to return the valve 33 to a closed position abutting against a valve seat 34a.

A valve unit housing 31 is formed from a heat-resistant steel such as cast iron and stainless steel. A through hole 35 that associates a fluid passage 34 with the outside is provided in the valve unit housing 31. The valve shaft 32 is inserted into the through hole 35. Further, a metallic filter unit 36 and a bush (a bushing section) 37 are provided around the upper end side and the lower end side of the through hole 35, respectively. Note that when the gas temperature is low, a shaft seal may be provided for the filter unit 36 in combination. One end side of the valve shaft 32 is pivotally supported by the bearing 24, and the other end side is pivotally supported by the bush 37.

An annular step is provided on the inner surface of the cylindrical fluid passage 34 to form the valve seat 34a. The elliptical valve 33 is fixed to the valve shaft 32; the valve 33 rotates about the rotation center axis X integrally with the valve shaft 32 to change the amount of clearance between the valve 33 and the valve seat 34a, thereby controlling the flow rate of the fluid.

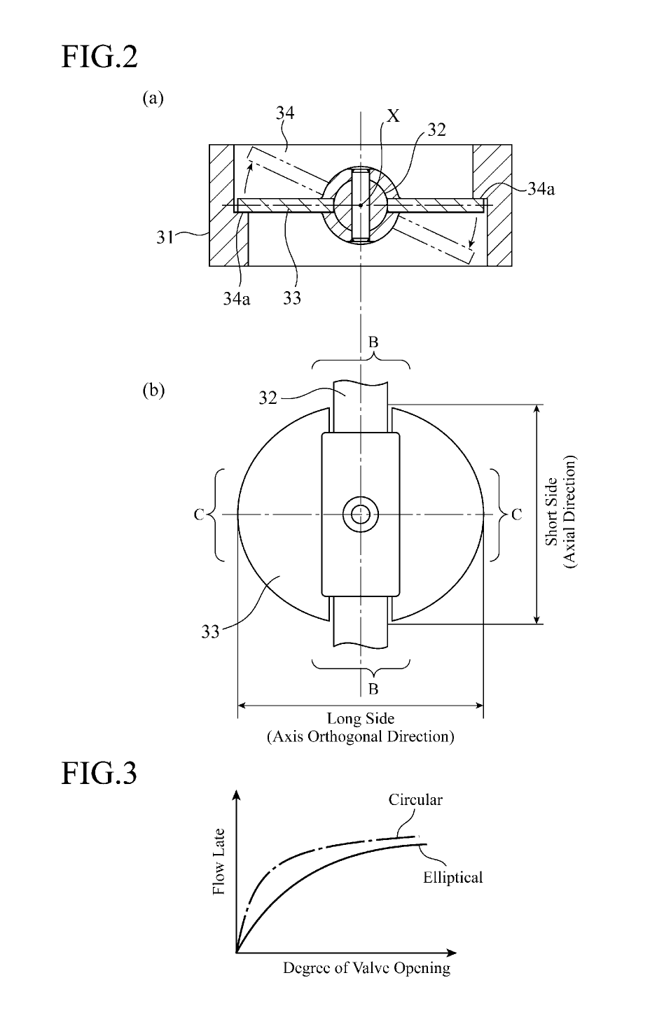

FIG. 2(a) is a sectional view of the valve unit 30 taken along a line A-A in FIG. 1, and FIG. 2(b) is an enlarged view of the extracted valve 33. The valve 33 takes the shape of an elliptical deformed circle having a shortened diameter in an axial direction parallel to the rotation center axis X and a lengthened diameter in a direction orthogonal to the axial direction (hereinafter, referred to as an axis orthogonal direction). Further, the valve seat 34a forms a seal by abutting against a front surface of a semicircle on one side of the valve 33 and a rear surface of a semicircle on the other side thereof about the rotation center axis X as a boundary.

However, the outer peripheral curved surface of the valve 33 is perpendicular to the front and rear surfaces and does not need to be processed into a special shape by an inclining process and so on. Thus, the valve can be manufactured at low cost as compared with a butterfly valve as shown in Patent Documents 1 to 4 previously discussed.

FIG. 3 is a graph showing a relationship between a degree of valve opening and a flow rate with regard to the elliptical valve 33 according to Embodiment 1 and a circular valve of a conventional step type valve. In the circular valve, left and right end portions C in the axis orthogonal direction are opened greatly at the start of a valve opening operation, and therefore the fluid tends to flow from the left and right end portions C in the axis orthogonal direction better than from upper and lower end portions B (see FIG. 2(b)) in the axial direction. As a result, the rising flow rate at the start of the valve opening operation is increased, which makes the flow control difficult.

On the other hand, as compared with the circular valve, the elliptical valve 33 according to Embodiment 1 has a narrower opening width in the left and right end portions C in the axis orthogonal direction at the same degree of valve opening, thereby suppressing the rising flow rate at the start of the valve opening operation. Further, an overlapping margin where the left and right end portions C of the valve 33 in the axis orthogonal direction abut against the valve seat 34a is increased, and further a clearance between the outer peripheral curved surface of the valve 33 and the fluid passage 34 is decreased; thus, a path through which the fluid flows at the start of the valve opening operation forms a labyrinth structure constituted by the valve 33, the fluid passage 34, and the valve seat 34a to restrain the flow. For this reason, the rising flow rate can be further suppressed. Therefore, the flow control at the start of the valve opening operation can be facilitated.

Furthermore, the overlapping margin where the valve 33 abuts against the valve seat 34a is larger in the left and right end portions C in the axis orthogonal direction, and therefore the fluid is less likely to leak through a clearance between the valve 33 and the valve seat 34a during the valve closing operation. On the other hand, although there is a slight clearance between the valve 33 and the valve shaft 32 in the upper and lower end portions B in the axial direction, the overlapping margin is provided other than the clearance, and therefore a valve seat leakage during the valve closing operation is hardly found. Note that the clearances in the upper and lower end portions B in the axial direction can be reduced or eliminated by selecting the materials and dimensions of the valve 33 and the valve shaft 32.

Moreover, the overlapping margin between the valve 33 and the valve seat 34a may be further increased such that not only the diameter of the valve 33 in the axis orthogonal direction is lengthened but also the steps at the positions C of both end parts in the axis orthogonal direction of the valve seat 34a are enlarged. According to this configuration, not only the valve seat leakage can be suppressed but also the labyrinth structure at the start of the valve opening operation is lengthened, and therefore the rising flow rate can be suppressed even smaller.

Next, described is an instance in which the fluid control valve according to Embodiment 1 is used under a high temperature, for example, an instance that is used as an EGRV (Exhaust Gas Recirculation Valve) disposed in a pipe through which a high temperature exhaust gas (up to 800° C.) flows.

When the high temperature fluid flows through the fluid passage 34, all the valve unit housing 31, valve shaft 32, and valve 33 all thermally expand. The valve 33 may increase or decrease in size relative to the fluid passage 34, depending on constituent materials of the parts and a temperature difference therebetween during an actual use. Further, when the valve shaft 32 extends toward the bush 37 side from the lower end portion of the bearing 24 as a starting point, it is also assumed that the position of the valve 33 is shifted.

When the high temperature fluid flows therein, with respect to the axis orthogonal direction, an expansion in the radial direction of the valve 33 and the valve unit housing 31 occurs, but a positional deviation of the valve shaft 32 in the axial direction due to a thermal expansion thereof in the direction of the bush 37 from the lower end side of the bearing 24 as a starting point need not be significantly considered. Therefore, a clearance required in the left and right end portions C in the axis orthogonal direction to prevent the valve 33 from biting into the fluid passage 34 may be decreased. Therefore, a biting due to a reduction in the clearance between the valve 33 and the fluid passage 34 at a high temperature can be avoided even when the diameter of the valve 33 is lengthened in the axis orthogonal direction. Further, the overlapping margin between the valve 33 and the valve seat 34a in the left and right end portions C in the axis orthogonal direction can be increased, and therefore the valve seat leakage during the valve closing operation can also be suppressed.

With respect to the axial direction, an expansion in the radial direction occurs in the valve 33 and the valve unit housing 31, while an expansion in the axial direction of the valve shaft 32 occurs due to a thermal expansion thereof in the direction of the bush 37 from the lower end side of the bearing 24 as a starting point. The effect of the expansion due to the high temperature is greater in the axial direction than in the axis orthogonal direction, and therefore a positional deviation of the valve 33 to the bush 37 side is also increased. Accordingly, a clearance required in the upper and lower end portions B in the axial direction to prevent the valve 33 from biting into the fluid passage 34 must be taken larger than the required clearance in the left and right end portions C. Therefore, a biting due to a reduced clearance between the valve 33 and the fluid passage 34 at the high temperature is avoided in such a manner that the diameter of the valve 33 in the axial direction is shortened. Further, the overlapping margin can be secured between the valve 33 and the valve seat 34a in the upper and lower end portions B in the axial direction, and therefore the valve seat leakage can be suppressed during the valve closing operation.

As mentioned above, in consideration of both the valve biting avoidance and the valve seat leakage suppression under the high temperature, when the dimensions of the parts are set, the valve can be used not only under the normal temperature but also under the high temperature.

Incidentally, the effects of the expansions in the parts where a high temperature fluid flows can be reduced, for example, when the valve 33 and the fluid passage 34 are provided by constituent materials having a similar linear expansion coefficient. In this case, the required clearance between the valve 33 and the fluid passage 34 can be suppressed still smaller, and also the overlapping margin between the valve 33 and the valve seat 34a can be enlarged, and therefore the rising flow rate can be further suppressed. As an example of materials having a similar linear expansion coefficient, the valve 33 is formed from stainless steel and the fluid passage 34 is formed from cast iron or stainless steel.

As described above, according to Embodiment 1, the step type valve is configured to include: the valve shaft 32 that rotates about the rotation center axis X; the valve 33 that rotates integrally with the valve shaft 32 and that has a deformed circular shape such that the diameter in the axis orthogonal direction orthogonal to the axial direction that is parallel to the rotation center axis X is longer than that in the axial direction; and the valve seat 34a having the annular step provided on the inner surface of the fluid passage 34 to abut against the front surface on one side of the valve 33 and the rear surface on the other side thereof about the rotation center axis X as a boundary. For this reason, the opening width between the valve 33 and the valve seat 34a at the start of a valve opening operation can be reduced, and also, especially, in the left and right end portions C in the axis orthogonal direction that make easily an effect on the rising flow rate, the overlapping margin between the valve 33 and the valve seat 34a is increased and further the clearance between the valve 33 and the fluid passage 34 is reduced to form the labyrinth structure; thus, the fluid is less likely to flow therethrough to thereby suppress the rising flow rate. Moreover, the overlapping margin is secured over almost the whole peripheries of the valve 33 and the valve seat 34a, and therefore the valve seat leakage during the valve closing operation can be suppressed. Furthermore, the clearance is formed between the outer peripheral curved surface of the valve 33 and the fluid passage 34, and therefore the biting can be avoided.

Further, even when the valve shaft 32 thermally expands under a high temperature to shift the position of the valve 33, the rising flow rate can be suppressed similarly under a normal temperature. Moreover, the clearance between the valve 33 and the fluid passage 34 is provided greatly in the axial direction in which the valve shaft 32 expands due to a thermal expansion, and therefore the valve 33 can be prevented from biting into the fluid passage 34 even under a high temperature. Furthermore, the overlapping margin between the valve 33 and the valve seat 34a can be secured even when the parts thermally expand, and therefore the valve seat leakage can be suppressed similarly at a normal temperature.

Further, according to Embodiment 1, not only the valve 33 is provided by the deformed circle but also the step of the valve seat 34a is deformed, so that the overlapping margin in which the valve 33 abuts against the valve seat 34a is made larger in the left and right end portions C in the axis orthogonal direction than in the upper and lower end portions B in the axial direction, and therefore, the labyrinth structure at the start of the valve opening operation is enlarged in the left and right end portions C in the axis orthogonal direction that makes easily an effect on the rising flow rate, and thereby, the rising flow rate can be suppressed even further. The valve seat leakage during the valve closing operation can also be suppressed.

Furthermore, according to Embodiment 1, the clearance between the valve 33 and the fluid passage 34 is made larger in the upper and lower end portions B in the axial direction than in the left and right end portions C in the axis orthogonal direction, and therefore the biting can be avoided even when the valve shaft 32 thermally expands at a high temperature such that the position of the valve 33 is shifted in the axial direction.

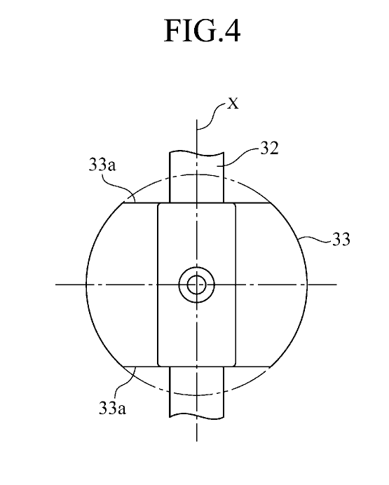

In the illustrated example of Embodiment 1, the valve 33 of the fluid control valve is provided by an elliptical shape, but it may be a deformed circular shape other than the elliptical shape. For example, in the case where the expansion of the valve shaft 32 is larger due to a thermal effect, as shown in FIG. 4, the upper and lower end portions in the axial direction of the elliptical (or circular) valve 33 each are cut away to provide a deformed circle in which cutout portions 33a are formed, so that the clearance between the valve 33 and the fluid passage 34 is further enlarged to avoid the biting.

Further, the fluid passage 34 and the valve seat 34a are provided by a cylindrical shape and an annular shape, respectively, and each can be modified to an elliptical shape.

### INDUSTRIAL APPLICABILITY

As described above, since the step type valve according to the present invention suppress the rising flow rate, and also enables the valve biting avoidance and the valve seat leakage suppression at a high temperature, it is suitable for use as an exhaust gas recirculation valve and so on.

1. A step type valve comprising:
a valve shaft that rotates about a rotation center axis;
a valve that rotates integrally with the valve shaft and that has a deformed circular shape such that a diameter in an axis orthogonal direction orthogonal to an axial direction parallel to the rotation center axis is longer than that in the axial direction; and
a valve seat having an annular step provided on an inner surface of a fluid passage to abut against a front surface on one side of the valve and a rear surface on the other side thereof about the rotation center axis as a boundary,
wherein an overlapping margin in which the valve abuts against the valve seat is made larger in both end portions in the axis orthogonal direction than in both end portions in the axial direction.

2. A step type valve comprising:
a valve shaft that rotates about a rotation center axis;
a valve that rotates integrally with the valve shaft and that has a deformed circular shape such that a diameter in an axis orthogonal direction orthogonal to an axial direction parallel to the rotation center axis is longer than that in the axial direction; and
a valve seat having an annular step provided on an inner surface of a fluid passage to abut against a front surface on one side of the valve and a rear surface on the other side thereof about the rotation center axis as a boundary,
wherein a clearance between the valve and the fluid passage is made larger in both end portions in the axial direction than in both end portions in the axis orthogonal direction.

3. The step type valve according to claim 1, wherein the valve has a deformed circular shape obtained by cutting away both end portions in an axial direction of a circle or an ellipse.

4. The step type valve according to claim 2, wherein the valve has a deformed circular shape obtained by cutting away both end portions in an axial direction of a circle or an ellipse.
